(19) United States
(12) Patent Application Publication
(10) Pub. No.: US 2007/0156654 A1
(43) Pub. Date: Jul. 5, 2007

(54) Method for displaying search results and contextually related items

(76) Inventor: Kalpana Ravinarayanan, Sunnyvale, CA (US)

Correspondence Address: HICKMAN PALERMO TRUONG & BECKER, LLP, 2055 GATEWAY PLACE, SUITE 550, SAN JOSE, CA, 95110, US

(21) Appl. No.: 11/370,315

(22) Filed: Mar. 7, 2006

Related U.S. Application Data
(60) Provisional application No. 60/755,559, filed on Dec. 29, 2005.

(51) Int. Cl. G06F 17/30

(52) U.S. Cl. 707/3

(57) ABSTRACT

A search query is received from a requestor. A results set is determined for the search query. Additional items that are contextually related to the search query are determined. In one aspect, the additional items relate to brand identifiers of sponsors that are contextually related to the search query. A web page is formed containing the result set items and the additional items. The result set items are presorted in a first alignment relative to each other. The first alignment may be a vertical alignment or a horizontal alignment. The additional items are presented in the first alignment relative to the result items, and in a second alignment relative to each other. The second alignment is the other of a vertical alignment and a horizontal alignment. The web page is transmitted to the requestor in response to the search query.

### PRIORITY CLAIM AND CROSS-REFERENCE TO RELATED APPLICATIONS

This application is related to and claims domestic priority from prior U.S. Provisional Application Ser. No. 60/755,559 (attorney docket number 50269-0720), filed on Dec. 29, 2005 entitled “Method For Displaying Search Results And Contextually Related Items,” by Ravinarayanan, the entire disclosure of which is hereby incorporated by reference as if fully set forth herein.

### COPYRIGHT

A portion of the disclosure of this patent document contains material which is subject to copyright protection. The copyright owner has no objection to the facsimile reproduction by anyone of the patent document of the patent disclosure, as it appears in the United States Patent and Trademark patent file or records, but otherwise reserves all copyright rights whatsoever.

### FIELD OF THE INVENTION

The present invention relates to search engines, and in particular, to displaying search results and contextually related items.

### BACKGROUND

A search engine is a computer program that helps a user to locate information. Using a search engine, a user can enter one or more search query terms and obtain a list of search results that contain or are associated with subject matter that matches those search query terms. While search engines may be applied in a variety of contexts, search engines are especially useful for locating resources that are accessible through the Internet. Resources that may be located through a search engine include, for example, files whose content is composed in a page description language such as Hypertext Markup Language (HTML). Such files are typically called pages. One can use a search engine to generate a list of Universal Resource Locators (URLs) and/or HTML links to files, or pages, that are likely to be of interest.

Search engine providers generate revenue by allowing sponsors to bid for representation on a page of search results. Some search engines present a sponsor in the form of an HTML hypertext link to the sponsor's web site. Typically, sponsors bid on keywords appearing in search queries, with the highest bidders having their HTML links presented on the page of search results along side of the search results.

In a pay-per-click model, a sponsor pays a fee each time that a user clicks on the sponsored HTML link. For example, a sponsor at the top of a list of HTML links may pay $0.15 each time a user clicks on the sponsored link. Thus, if no users “click through” to the sponsor's site, no revenue is generated for the search engine and the sponsor receives no benefit from visits to the sponsor's site. In some cases, a sponsor may place a very high bid to be included in the sponsor list, even though the sponsor realizes that few users will click through to the sponsor's site.

However, there is a limited amount of space on a web page to use for sponsored results. Thus, only the top few bidders will be displayed in the search results page. Therefore, all potential sponsors who do not make the top of the list will fail to receive any representation. Thus, sponsors may bid up the price for the top few spots to attempt to get any representation at all. However, inclusion on the sponsor list does not mean that users will click through to the sponsor's site.

The net result is unfortunate for both potential sponsors and for the search engine provider. Potential sponsors lose out by having to overbid to get any representation. Search engine providers lose out by displaying sponsors that do not have high click-through rates.

Sponsors have the additional problem of trying to determine how to attract the correct users for clicking through to the sponsor site. Typically, a sponsor will provide a textual description with the HTML link to the sponsor's site to help the user decide if the user wishes to click through. However, if the sponsor's text does not convey an accurate meaning to the user, the user may fail to click through even though the sponsor's site may be of interest to the user. Furthermore, the user may click through only to find the sponsor's site is of little interest. Thus, a poorly communicated textual description causes the sponsor to have to pay for click-throughs that do not benefit the sponsor and to miss opportunities to attract user traffic.

Moreover, the aforementioned problems cause the user to suffer from a poor experience and to be less likely to pursue clicking through to sponsors' sites in the future.

Thus, improved techniques are needed for sponsorship of web search results.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is an illustration of a page of web search results with a banner of items that are contextually related to the search query, in accordance with a first embodiment of the present invention.

FIG. 2 is a flowchart illustrating steps of a process of forming a web page including items that are contextually related to the search query, in accordance with an embodiment of the present invention.

FIG. 3 is a flowchart illustrating steps of a process of determining appropriate sponsors for inclusion in the banner, in accordance with an embodiment of the present invention.

FIG. 4 is an illustration of a page of web search results with a banner of items that are contextually related to the search query, in accordance with a second embodiment of the present invention.

FIG. 5 is a block diagram that illustrates a computer system upon which an embodiment of the invention may be implemented.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

Overview

Techniques are provided for forming a web page containing search results. According to one such technique, a search query is received from a requestor. A results set is determined for the search query. For example, a search engine may receive the request and determine identifiers of web pages that match the search query, along with a relevance that defines how close the match is. The results set can include the more highly ranked search results. Additional items that are contextually related to the search query are determined. In one aspect, the additional items relate to brand identifiers of sponsors that are contextually related to the search query. A web page is formed containing the result set items and the additional items.

The result set items are presorted in a first alignment relative to each other. For example, search results are aligned vertically relative to each other wherein higher ranked results are presented closer to the top. The first alignment may be a vertical alignment or a horizontal alignment. The additional items are presented in the first alignment relative to the result set items, and in a second alignment relative to each other. The second alignment is the other of a vertical alignment and a horizontal alignment. For example, the additional items are presented in a horizontal line above the search results. The web page is transmitted to the requestor in response to the search query.

### FIRST EMBODIMENT OF A WEB PAGE

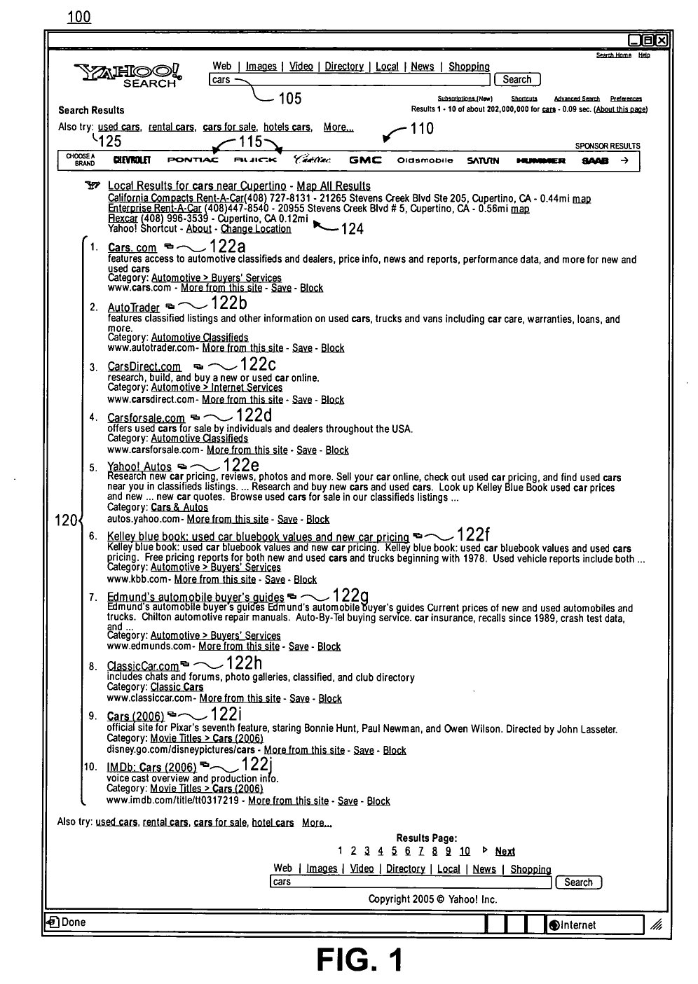

FIG. 1 depicts a web page 100 including items that are contextually related to the search query, in accordance with an embodiment of the present invention. The web page 100 includes a banner 110 having items 115 that are contextually related to the search query 105, in addition to search results 120. The banner items 115 are sponsored results, in accordance with one embodiment. However, the banner items 115 can be contextually related to the search query 105 even though they are not sponsored results.

In one embodiment, the banner items 115 are brand identifiers. A brand identifier is defined herein as a symbolic embodiment of information connected with a product or service. A brand identifier typically includes a name, logo, and/or other visual elements such as images, fonts, color schemes, or symbols. In FIG. 1, the brand identifiers are brand names, but the brand identifiers are not limited to being the name of a brand. More particularly, the brand identifiers in FIG. 1 include letters that form words or acronyms. However, a brand identifier is not required to have letters that form a word, abbreviation, acronym, or other logical unit. In one embodiment, a brand identifier includes a combination of letters and one or more symbols that are not letters. In one embodiment, a brand identifier includes one or more symbols with no letters. A brand identifier may include, but is not limited to, brand names, trade marks, trade names, and service marks.

Each banner item 115 has a HTML link associated with it, in accordance with one embodiment. The HTML link may be to a sponsor's web site. In one aspect, the only information in the banner 110 to describe the web site is the banner item 115. This allows the banner 110 to efficiently use space of the web page, while still allowing for high sponsorship revenue. The banner items 115 are efficiently displayed in that a relatively small amount of space is used to display the banner 110 because the banner items 115 themselves are able to efficiently convey a substantial meaning to the user. Thus, there is no need for an additional textual description to augment the brand identifiers.

Moreover, the banner items 115 are able to accurately and quickly convey a meaning to the user. For example, there is substantial variation in the font used in the brand identifiers in FIG. 1, which allows the sponsors to quickly and accurately establish a familiar meaning to the user. Thus, a user is able to accurately and quickly determine whether the user wishes to click on the banner item 115 to go to the sponsor's site. Moreover, the sponsor benefits by attracting user's that are truly interested in the sponsor's site.

In the embodiment depicted in FIG. 1, the search results 120 contain a set of search items that are presorted with a vertical alignment relative to each other. In another embodiment, the search items are aligned horizontally relative to one another. The search items include a list of ten ranked items 122a-125, as well as a “shortcut” 124 just above the first ranked item 122a, in this embodiment. In this case, the shortcut 124 provides links to items that may be of interest to a user near Cupertino, Calif.

The search results 120 do not have to include the type of search items depicted in FIG. 1. In one embodiment, the search results 120 do not include any shortcuts 124. In another embodiment, the search results 120 do not include ranked search items 122.

The banner 110 itself is presented in a vertical alignment relative to the search items, in this embodiment. The banner items 115 are aligned horizontally with respect to one another, in this embodiment.

More generally, the search items are presorted in a first alignment relative to each other, wherein the first alignment is one of a vertical alignment and a horizontal alignment. The banner items 115 are presented in the first alignment relative to the search items, and in a second alignment relative to each other. If the first alignment is horizontal, then the second alignment is vertical. If the first alignment is vertical, then the second alignment is horizontal.

While the banner 110 is presented above the search results 120, the banner could be placed elsewhere. In another embodiment, the banner 110 is presented below the search results 120. The web page can have other items between the banner 110 and the search results 120. For example, the also try suggestions 125 that are above the banner 110 could be displayed between the banner 110 and the search results 120.

In one embodiment, the banner items 115 are displayed as icons. The term icon means any graphical image that is intended to convey a meaning to a user. For example, an icon could be a company logo or a brand name having specialized characteristics. The specialized characteristics can include font, color, special symbols, etc.

### Forming a Web Page in Accordance with an Embodiment of the Present Invention

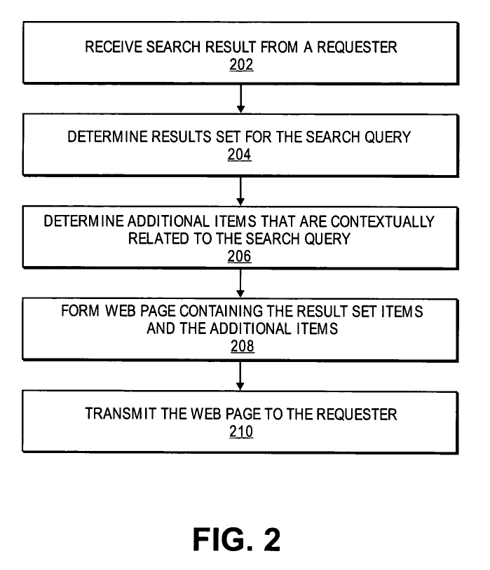

FIG. 2 is a flowchart illustrating a process of forming a page of web search results including items that are contextually related to the search query, in accordance with an embodiment of the present invention. In step 202, a search result is received from a requestor. In step 204, a results set for the search query is determined. The results set includes a plurality of result set items. For example, a search engine can order the result set items by assigning a rank to each result in the list. The search engine may rank the results according to relevance. Relevance is a measure of how closely the subject matter of the result matches query terms. When the list is sorted by rank, a result with a relatively higher rank may be placed closer to the head of the list than a result with a relatively lower rank. Thus, the items in the results set are selected for inclusion on the web page because of their relatively high ranking in terms of relevance to the search. The result set items can include information such as shortcuts, as well.

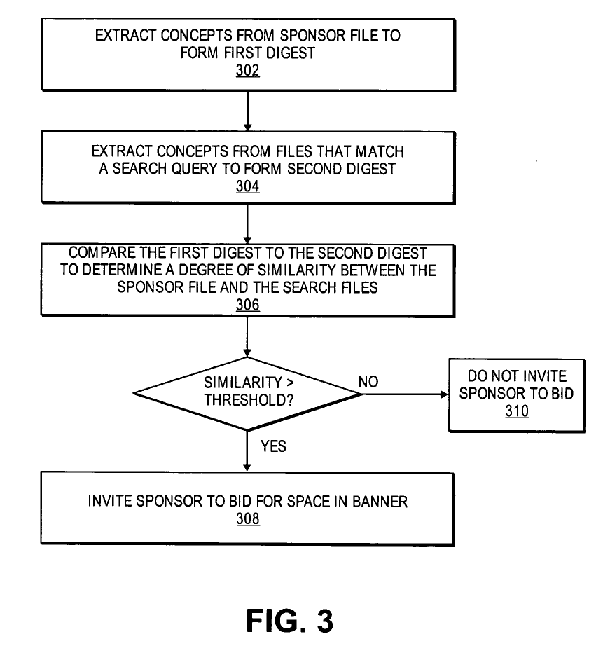

In step 206, a plurality of additional items that are contextually related to the search query are determined. One possible way of determining additional items is described hereinafter in reference to FIG. 3. In one aspect, the additional items relate to brand identifiers of sponsors that are contextually related to the search query. Thus, the additional items, while being contextually related to the search query, are not necessarily selected for inclusion on the web page because of a high ranking in terms of relevance to the search query. In one embodiment, sponsors are permitted to bid for a position in a banner of contextually related items.

In step 208, a web page is formed containing the result set items and the additional items. The results set items are presorted in a first alignment relative to each other. The first alignment may be a vertical alignment or a horizontal alignment. The additional items are presented in the first alignment relative to the result items, and in a second alignment relative to each other. The second alignment is the other of a vertical alignment and a horizontal alignment.

In step 210, the web page is transmitted to the requestor in response to the search query.

Determining which Contextually Related Items to Include with the Search Results of a Search Query

In one embodiment, the decision about which contextually related items to include with the search results of a search query is performed in two phases. In the first phase, it is determined which sponsors are allowed to bid on a search term. In the second phase, it is determined which sponsors were the highest bidders on a search term. Each of these phases shall be described in greater detail below with reference to FIG. 3.

However, this two-phase approach is merely one example of a technique for determining which contextually related items to include with the search results of a search query. Other techniques can be used.

### Determining which Sponsors to Include in Banner

Inclusion of a sponsor in the banner may be based on a bidding process. The bidding may be limited to sponsors that are appropriate for the query. FIG. 3 describes a process for determining appropriate sponsors, in accordance with one embodiment. According to this embodiment, if a sponsor wishes to take part in the bidding for inclusion in the banner, the sponsor submits one or more web pages from which either terms or concepts are extracted. For example, a sponsor submits one or more web pages that are associated with the sponsor's web site. These may be the web pages that are linked to when a user clicks on the banner item 155 for the sponsor. However, these could be other web pages. As a particular example, an automobile manufacturer may submit one or more web pages with subject matter having content that is representative of the concepts that may appear in a search query upon which the manufacturer may wish to bid for sponsorship.

In step 302, a sponsor set is formed by extracting terms from a sponsor file, which may include web pages. For example, terms are extracted from one or more web pages provided by the automobile manufacture.

In step 304, terms are extracted from web pages that match a search query to form a search result set. The search result set need not be based on all of the web pages that match the search query. For example, the search result set may be based on terms extracted from just the more highly ranked search results. Thus, the highest-ranked web pages in the results set of the search query in FIG. 1 may be analyzed to form a search result set.

In step 306, the terms in the sponsor set are compared to the terms in the search result set to determine a degree of similarity between the sponsor files and the search result web pages. The comparison does not have to be based on the actual terms that are extracted from the sponsor file and search results. In one embodiment, concepts are formed, based on an analysis of the sponsor file and search results. For example, an automobile manufacture's web site may never use the term “car,” instead using the term “automobile.” However, the terms “automobile” and “car” are similar concepts. Therefore, the sponsor set can be augmented with the term “car,” which is conceptually similar to the term “automobile.” Thus, a search based on the term “car,” will likely have a high degree of similarity with the sponsor set.

If the similarity between the sponsor set and the search result set is greater than a threshold, then the sponsor associated with the sponsor set is determined to be eligible to bid the search query (or a keyword therein). For example, if the automobile manufacture's web pages are determined to be sufficiently similar to the web pages returned by the search query, then the automobile manufacturer is allowed to bid for sponsorship of the search query.

If the sponsor set and the search result set are not sufficiently similar, then a determination is made to not invite the sponsor to bid on this search query, in step 310. Even if a sponsor is not invited to bid, a sponsor is allowed to bid, in one embodiment.

Other techniques may be used to determine which sponsors are allowed to bid for placement in the banner. In one embodiment, inclusion in the banner is limited to terms that are related to the specific sponsor. For example, for the sponsor to be included in the banner associated with search results, the search query should include a reference to the name of the sponsor, a sponsor trade mark or service mark, or a particular service or product provided by the sponsor. The degree of relationship to the sponsor need not be so restrictive, however. For example, the relationship could be based on a line or business or type of service or product provided by the sponsor.

Another technique for determining whether to include a sponsor is based on a comparison of the sponsor's page to search results pages. For example, web pages can be categorized into different types, wherein one or more categories for the sponsor's web pages are compared to one or more categories for the search results. Alternatively, the types of pages that link to the sponsor's web pages can be compared to the types of pages in the search results. Still another technique is to determine what search queries are likely to return the sponsor's web page(s) as a highly ranked result. The sponsor is included in the banner for results for such search queries.

As previously discussed, it is not required that the bidding be closed to a particular group of potential sponsors. In one embodiment, search terms (or keywords) are put up for bid, wherein any entity may bid for a place in the banner that is displayed along with search results for a search query having that term (or keyword).

### SELECTING THE WINNING BIDDERS

There may be several sponsors that are eligible to bid on any given search query (or keyword). Likewise, any given sponsor may be eligible to bid on several queries (or keywords). In step 308, a sponsor receives a list of search queries or keywords for which the sponsor is eligible to bid upon. The sponsor may then place a bid on one or more of the search queries or keywords/key phrases. For example, an automobile manufacturer may be eligible to bid on search queries or keywords either of which may include terms such as, “cars”, “autos”, “automobiles”, and “car dealers.”

The automobile manufacturer bids on the various search queries or keywords/key phrases are compared to other bids with the highest bidders getting a spot in the banner (FIG. 1, 110). The order of sponsors in the banner 110 may be ranked in accordance with the amount bid, although this is not required. For example, the sponsor that made the highest bid for the search query “cars” might be awarded the leftmost position in the banner 110.

Alternative Presentation of Search Results

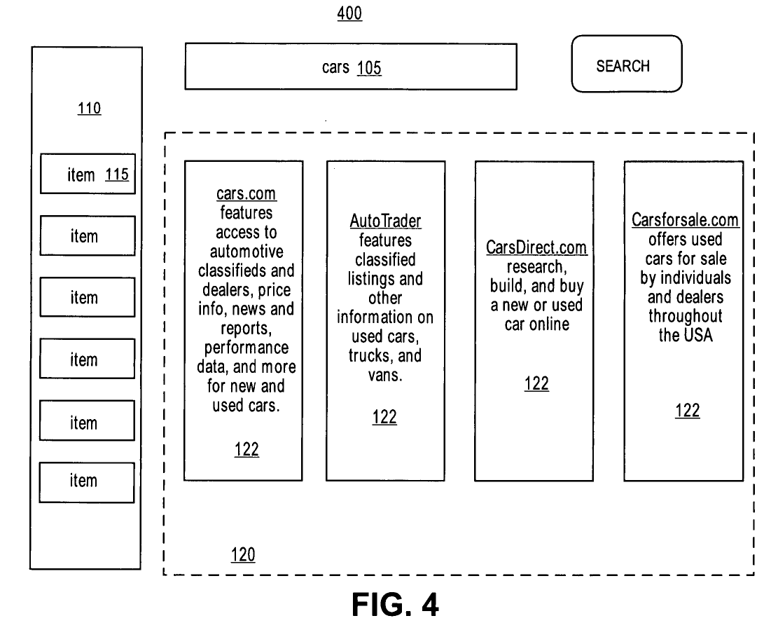

FIG. 4 is an illustration of a web page 300 including results that are contextually related to the search query, in accordance with another embodiment of the present embodiment. In this embodiment, the items 122 in the search results 120 are aligned horizontally with respect to each other. The banner 110 is aligned horizontally relative to the items 122 in the search results 120. The banner items 115 are aligned vertically with respect to each other.

Implementation Details—Hardware Overview

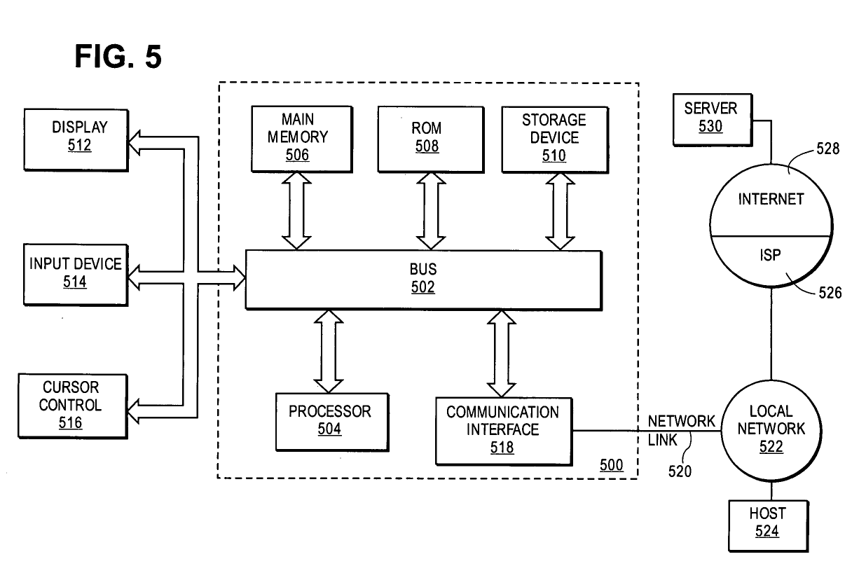

FIG. 5 is a block diagram that illustrates a computer system 500 upon which an embodiment of the invention may be implemented. Computer system 500 includes a bus 502 or other communication mechanism for communicating information, and a processor 504 coupled with bus 502 for processing information. Computer system 500 also includes a main memory 506, such as a random access memory (RAM) or other dynamic storage device, coupled to bus 502 for storing information and instructions to be executed by processor 504. Main memory 506 also may be used for storing temporary variables or other intermediate information during execution of instructions to be executed by processor 504. Computer system 500 further includes a read only memory (ROM) 508 or other static storage device coupled to bus 502 for storing static information and instructions for processor 504. A storage device 510, such as a magnetic disk or optical disk, is provided and coupled to bus 502 for storing information and instructions.

Computer system 500 may be coupled via bus 502 to a display 512, such as a cathode ray tube (CRT), for displaying information to a computer user. An input device 514, including alphanumeric and other keys, is coupled to bus 502 for communicating information and command selections to processor 504. Another type of user input device is cursor control 516, such as a mouse, a trackball, or cursor direction keys for communicating direction information and command selections to processor 504 and for controlling cursor movement on display 512. This input device typically has two degrees of freedom in two axes, a first axis (e.g., x) and a second axis (e.g., y), that allows the device to specify positions in a plane.

The invention is related to the use of computer system 500 for implementing the techniques described herein. According to one embodiment of the invention, those techniques are performed by computer system 500 in response to processor 504 executing one or more sequences of one or more instructions contained in main memory 506. Such instructions may be read into main memory 506 from another machine-readable medium, such as storage device 510. Execution of the sequences of instructions contained in main memory 506 causes processor 504 to perform the process steps described herein. In alternative embodiments, hard-wired circuitry may be used in place of or in combination with software instructions to implement the invention. Thus, embodiments of the invention are not limited to any specific combination of hardware circuitry and software.

The term “machine-readable medium” as used herein refers to any medium that participates in providing data that causes a machine to operation in a specific fashion. In an embodiment implemented using computer system 500, various machine-readable media are involved, for example, in providing instructions to processor 504 for execution. Such a medium may take many forms, including but not limited to, non-volatile media, volatile media, and transmission media. Non-volatile media includes, for example, optical or magnetic disks, such as storage device 510. Volatile media includes dynamic memory, such as main memory 506. Transmission media includes coaxial cables, copper wire and fiber optics, including the wires that comprise bus 502. Transmission media can also take the form of acoustic or light waves, such as those generated during radio-wave and infra-red data communications. All such media must be tangible to enable the instructions carried by the media to be detected by a physical mechanism that reads the instructions into a machine.

Common forms of machine-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, and EPROM, a FLASH-EPROM, any other memory chip or cartridge, a carrier wave as described hereinafter, or any other medium from which a computer can read.

Various forms of machine-readable media may be involved in carrying one or more sequences of one or more instructions to processor 504 for execution. For example, the instructions may initially be carried on a magnetic disk of a remote computer. The remote computer can load the instructions into its dynamic memory and send the instructions over a telephone line using a modem. A modem local to computer system 500 can receive the data on the telephone line and use an infra-red transmitter to convert the data to an infra-red signal. An infra-red detector can receive the data carried in the infra-red signal and appropriate circuitry can place the data on bus 502. Bus 502 carries the data to main memory 506, from which processor 504 retrieves and executes the instructions. The instructions received by main memory 506 may optionally be stored on storage device 510 either before or after execution by processor 504.

Computer system 500 also includes a communication interface 518 coupled to bus 502. Communication interface 518 provides a two-way data communication coupling to a network link 520 that is connected to a local network 522. For example, communication interface 518 may be an integrated services digital network (ISDN) card or a modem to provide a data communication connection to a corresponding type of telephone line. As another example, communication interface 518 may be a local area network (LAN) card to provide a data communication connection to a compatible LAN. Wireless links may also be implemented. In any such implementation, communication interface 518 sends and receives electrical, electromagnetic or optical signals that carry digital data streams representing various types of information.

Network link 520 typically provides data communication through one or more networks to other data devices. For example, network link 520 may provide a connection through local network 522 to a host computer 524 or to data equipment operated by an Internet Service Provider (ISP) 526. ISP 526 in turn provides data communication services through the world wide packet data communication network now commonly referred to as the “Internet” 528. Local network 522 and Internet 528 both use electrical, electromagnetic or optical signals that carry digital data streams. The signals through the various networks and the signals on network link 520 and through communication interface 518, which carry the digital data to and from computer system 500, are exemplary forms of carrier waves transporting the information.

Computer system 500 can send messages and receive data, including program code, through the network(s), network link 520 and communication interface 518. In the Internet example, a server 530 might transmit a requested code for an application program through Internet 528, ISP 526, local network 522 and communication interface 518.

The received code may be executed by processor 504 as it is received, and/or stored in storage device 510, or other non-volatile storage for later execution. In this manner, computer system 500 may obtain application code in the form of a carrier wave.

In the foregoing specification, embodiments of the invention have been described with reference to numerous specific details that may vary from implementation to implementation. Thus, the sole and exclusive indicator of what is the invention, and is intended by the applicants to be the invention, is the set of claims that issue from this application, in the specific form in which such claims issue, including any subsequent correction. Any definitions expressly set forth herein for terms contained in such claims shall govern the meaning of such terms as used in the claims. Hence, no limitation, element, property, feature, advantage or attribute that is not expressly recited in a claim should limit the scope of such claim in any way. The specification and drawings are, accordingly, to be regarded in an illustrative rather than a restrictive sense.

What is claimed is:

1. A method comprising performing a machine-executed operation involving instructions, wherein the machine-executed operation is at least one of:
A) sending the instructions over transmission media;
B) receiving the instructions over transmission media;
C) storing the instructions onto a machine-readable storage medium; and
D) executing the instructions;
wherein the instructions are instructions which, when executed by one or more
processors, cause the one or more processors to perform the steps of:
receiving a search query from a requestor;
determining a results set for the search query;
wherein the results set includes a plurality of result set items;
determining a plurality of additional items that are contextually related to the search query;
forming a web page in which:
(a) the plurality of results set items are presorted in a first alignment relative to each other, wherein the first alignment is one of a vertical alignment and a horizontal alignment; and
(b) the plurality of additional items are presented in the first alignment relative to the plurality of result set items, and in a second alignment relative to each other, wherein the second alignment is the other of a vertical alignment and a horizontal alignment; and
transmitting the web page to the requestor in response to the search query.

2. A method as recited in claim 1, wherein the first alignment is a vertical alignment and the second alignment is a horizontal alignment.

3. A method as recited in claim 1, wherein the first alignment is a horizontal alignment and the second alignment is a vertical alignment.

4. A method as recited in claim 1, wherein the plurality of additional items are presented above the plurality of results set items on the web page.

5. A method as recited in claim 1, wherein the plurality of additional items are presented in a banner.

6. A method as recited in claim 1, wherein the plurality of additional items are icons.

7. A method as recited in claim 1, wherein the plurality of additional items are brand identifiers.

8. A method as recited in claim 7, wherein the brand identifiers comprise letters that form logical units.

9. A method as recited in claim 7, wherein the brand identifiers comprise images.

10. A method as recited in claim 1, wherein the additional items include one or more of:
brand names, trade marks, trade names, and service marks associated with sponsors of the web page.

11. A method as recited in claim 1, wherein at least two of the additional items are presented in different fonts from each other.

12. A method as recited in claim 10, wherein the different fonts are associated with a brand identifier of the sponsors associated with the additional items having the different fonts from each other.

13. A method as recited in claim 1, wherein the result set items comprise items that match the search query with a high relevancy ranking.

14. A method as recited in claim 1, wherein the plurality of additional items are presented as icons.

15. A method as recited in claim 1, wherein the plurality of additional items are presented as icons that can be selected to link to a sponsor's web site.

16. A method as recited in claim 1, wherein the plurality of additional items are selected based on bids to be included among the additional items for at least one term in the search query.

17. A method as recited in claim 1, wherein the determining a plurality of additional items comprises:
extracting terms from a file associated with a first sponsor to form a first set;
extracting terms from web pages associated with the result set items to form a second set; and
comparing the first set to the second set to determine a degree of similarity between the document and the web pages associated with the results set items; and
if the degree if similarity is greater than a threshold, classifying the search query as being eligible for the first sponsor to bid for placement of a sponsor item among said additional items.

18. A method comprising performing a machine-executed operation involving instructions, wherein the machine-executed operation is at least one of:
A) sending the instructions over transmission media;
B) receiving the instructions over transmission media;
C) storing the instructions onto a machine-readable storage medium; and
D) executing the instructions;
wherein the instructions are instructions which, when executed by one or more
processors, cause the one or more processors to perform the steps of:
receiving a search query from a requestor;
determining a results set for the search query;
wherein the results set includes a plurality of result set items;
determining a plurality of brand identifiers that are contextually related to the search query;
forming a web page in which:
(a) the plurality of result set items are presorted in a ranking according to relevance to the search query; and
(b) the plurality of brand identifiers are presented in a banner, wherein for each of the brand identifiers the banner has an embedded link that can be selected to link to a web site associated with the brand identifier, and wherein the only information in the banner to describe the web site is the brand identifier; and
transmitting the web page to the requestor in response to the search query.

19. A method as recited in claim 18, wherein the brand identifiers comprises letters that form logical units.

20. A method as recited in claim 18, wherein the brand identifiers comprise images.

21. A method as recited in claim 18, wherein at least two of the brand identifiers are presented in different fonts from each other.

22. A method as recited in claim 25, wherein the different fonts are specified by the sponsors associated with the additional items having the different fonts from each other.

23. A method as recited in claim 18, wherein the brand identifiers are brand names associated with sponsors of the web page.

24. A method as recited in claim 18, wherein the plurality of brand identifiers are presented as icons.

25. A method as recited in claim 18, wherein the plurality of brand identifiers are selected based on bids to be included among the additional items for at least one term in the search query.
